(19) United States
(12) Patent Application Publication
(10) Pub. No.: US 2022/0148212 A1
(43) Pub. Date: May 12, 2022

(54) SURFACE TENSION MEASUREMENT METHOD BASED ON AXISYMMETRIC DROPLET CONTOUR CURVE

(71) Applicant: SHANGHAI INSTITUTE OF CERAMICS, CHINESE ACADEMY OF SCIENCES, Shanghai (CN)

(72) Inventors: Liping YANG, Shanghai (CN); Qiu ZHONG, Shanghai (CN); Jun WANG, Shanghai (CN); Huidong LI, Shanghai (CN); Ye TAO, Shanghai (CN); Wenbing WANG, Shanghai (CN); Zijun XU, Shanghai (CN); Caiyun LUO, Shanghai (CN)

(21) Appl. No.: 17/437,159

(22) PCT Filed: Jan. 22, 2020
(86) PCT No.: PCT/CN2020/073795

§ 371 Date: Sep. 8, 2021

(30) Foreign Application Priority Data
Mar. 11, 2019 (CN) 201910181420.7
Mar. 11, 2019 (CN) 201910181440.4

(51) Int. Cl. G06T 7/62; G06T 7/68; G01N 13/02

(52) U.S. Cl. CPC G06T 7/62; G06T 7/68; G01N 2013/0208; G01N 2013/0283; G01N 13/02

(57) ABSTRACT

Disclosed is a method for measuring surface tension based on an axisymmetric droplet contour curve. The method comprises: photographing a suspended droplet image, and extracting a droplet contour curve; selecting a measurement point on the droplet contour curve; and calculating the surface tension of a liquid using the following formula

$$σ = \frac{Δρ gV + P π {R}^{2}}{2 π R sin ( θ )} ,$$

wherein σ is the surface tension of the liquid, Δρ is the density difference between the liquid and the atmosphere, g is the local gravitational acceleration, P is the pressure at the cross section of the droplet cut from a horizontal plane of the measurement point, R is the radius of a circular surface formed by cutting the droplet, θ is the inclination angle between the tangent line of the measurement point on the droplet and the horizontal plane, and V is the droplet volume at the lower part of the cross section of the droplet.

### TECHNICAL FIELD

The invention belongs to the technical field of physical property measurement, and relates to a surface tension measurement method based on an axisymmetric droplet contour curve.

### BACKGROUND

Surface tension is one of the most important thermophysical properties in fluid mechanics. It has an important influence on the heat and mass transfer of the fluid interface, as well as the flow and heat transfer of the micro-shrinkage channel, and thus has become the focus of related research. Surface tension measurement can provide relevant information about the interaction between gas and liquid, and liquid and liquid. From this information, it can be deduced that the material has various important characteristics such as adhesion, infiltration, biocompatibility, lubrication, and adsorption, so as to provide important support for the development of related science and technology.

The measurement methods mainly include a maximum bubble method, a maximum tension method, a capillary method, a drop weight method, a droplet contour method, and the like. Among them, the droplet contour method requires fewer measurement samples, has higher accuracy and a wide use temperature range, which is widely applied. However, the droplet contour method includes performing a fitting solution to each point on the droplet profile, which involves differential equations and optimization solutions, and the solution process is complicated.

### SUMMARY

The purpose of the present invention is to provide a surface tension measurement method based on an axisymmetric droplet contour curve in order to solve the above-mentioned problems, which requires fewer samples, has a simple calculation process, and is convenient and quick.

The present invention is realized through the following technical solutions. In one aspect, a method for measuring surface tension based on an axisymmetric droplet contour curve is provided, which includes the following steps:

photographing a suspended droplet image, and extracting a droplet contour curve;

selecting a measurement point on the droplet contour curve; and

measuring the following geometrical parameters related to the selected measurement points on the droplet contour curve, and calculating the surface tension of a liquid using the following formula:

$$σ = \frac{Δρ gV + P π {R}^{2}}{2 π R sin ( θ )} ,$$

wherein σ is the surface tension of the liquid, Δρ is a density difference between the liquid and the atmosphere, g is a local gravitational acceleration, P is a pressure at the cross section of the droplet cut from a horizontal plane of the measurement point, R is the radius of a circular surface formed by cutting the droplet from the horizontal plane of the measurement point, θ is an inclination angle between a tangent line of the measurement point on the droplet and the horizontal plane, and V is a droplet volume at a lower part of the cross section of the droplet cut from the horizontal plane of the measurement point.

The present invention has the following technical advantages: by measuring the geometric parameters of a point on the surface of the axisymmetric droplet and measuring the liquid volume related to the point, the surface tension value can be obtained simply, complicated calculation is not needed, and calculation time is saved. In the case of uneven surface tension, the surface tension at any point on the liquid can be easily obtained.

Preferably, when an upper end surface of the droplet is a plane, the pressure P is obtained by the formula P=ΔρgH, where H is a height of the cross section from the upper end surface of the droplet.

It may also include the following step:

Layering the images in a height direction by pixels, the height of each layer being only one pixel, wherein

the volume V is calculated by a formula

$$V = π {\sum }_{i = 0}^{N} {r}^{2} h ,$$

wherein his the true height of each pixel of the image, i is the calculated pixel layer, i=0 is the pixel layer where the measurement point is located, i=N is the pixel layer at the apex of the droplet contour curve, and r is the radius of the droplet contour curve on the i-th pixel layer.

On the other hand, the present invention also provides a method for measuring surface tension based on an axisymmetric droplet contour curve, which comprises the following steps:

photographing a suspended droplet image, and extracting a droplet contour curve;

selecting two measurement points that are not on the same horizontal plane on the droplet contour curve; and

measuring geometrical parameters related to the selected measurement point on the droplet contour curve, and calculating a surface tension of a liquid by means of the formula:

$$σ = \frac{Δρ g ( {V}_{1} {r}_{2}^{2} - {V}_{2} {r}_{1}^{2} ) - Δ ρ g Δ h π {r}_{1}^{2} {r}_{2}^{2}}{2 π {r}_{1} {r}_{2} ( {r}_{2} sin {θ}_{1} - {r}_{1} sin {θ}_{2} )} ,$$

wherein α is the surface tension of the liquid, Δρ is a density difference between the liquid and the atmosphere, g is a local gravitational acceleration, Δh is a height difference between the two measurement points, r₁ and r₂ are respectively the radius of the circular surface formed by intercepting the droplet through the horizontal plane of the two selected measurement points, θ₁ and θ₂ are respectively inclination angles between a tangential line of the two selected measurement points on the droplet and the horizontal plane, and V₁ and V₂ are respectively a droplet volume below the cross section formed by cutting the droplet from the horizontal plane of the two selected measurement points.

Preferably, the droplet image is layered by pixels in the height direction when calculating the liquid volume, and the droplet volume from the measurement point to the apex of the droplet contour curve is calculated by the formula

$$V = π {\sum }_{i = 0}^{N} {r}^{2} h ,$$

wherein V is the calculated liquid volume, h is the true height of each pixel in the image, i is the true height of each pixel of the image, i is the calculated pixel layer, i=0 is the pixel layer where the measurement point is located, i=N is the pixel layer at the apex of the droplet contour curve, and r is the radius of the droplet contour curve on the i-th pixel layer.

In another aspect, the present invention also provides a method for measuring surface tension based on an axisymmetric droplet contour curve, which comprises the following steps:

photographing a suspended droplet image, and extracting a droplet contour curve;

selecting two measurement points that are not on the same horizontal plane on the droplet contour curve;

and measuring geometrical parameters related to the selected measurement point on the droplet contour curve, and calculating a surface tension of a liquid using the following formula:

$$σ = \frac{Δρ g Δ h π {r}_{1}^{2} {r}_{2}^{2} - Δ ρ g ( {V}_{1} {r}_{2}^{2} - {V}_{2} {r}_{1}^{2} )}{2 π {r}_{1} {r}_{2} ( {r}_{2} sin {θ}_{1} - {r}_{1} sin {θ}_{2} )} ,$$

wherein σ is the surface tension of the liquid, Δρ is a density difference between the liquid and the atmosphere, g is a local gravitational acceleration, Δh is a height difference between the two measurement points, r₁ and r₂ are respectively the radius of a circular surface formed by intercepting the droplet through the horizontal plane of the two selected measurement points, θ₁ and θ₂ are respectively inclination angles between a tangential line of the two selected measurement points on the droplet and the horizontal plane, and V₁ and V₂ are respectively a droplet volume below the cross section formed by cutting the droplet from the horizontal plane of the two selected measurement points.

Preferably, the droplet image is layered by pixels in the height direction when calculating the liquid volume, and the droplet volume from the measurement point to the apex of the droplet contour curve is calculated by the formula

$$V = π {\sum }_{i = 0}^{N} {r}^{2} h ,$$

wherein V is the calculated liquid volume, h is the true height of each pixel in the image, i is the true height of each pixel of the image, i is the calculated pixel layer, i=0 is the pixel layer where the measurement point is located, i=N is the pixel layer at the apex of the droplet contour curve, and r is the radius of the droplet contour curve on the i-th pixel layer.

The present invention has the following technical advantages: by measuring the geometric parameters of a point on the surface of the axisymmetric droplet and measuring the liquid volume related to the point, the surface tension value can be obtained simply, complicated calculation is not needed, and calculation time is saved. In the case of uneven surface tension, the surface tension at any point on the liquid can be easily obtained.

### The Effect of the Present Invention

Fewer samples are needed, and the calculation process is simple, convenient, and quick. The surface tension value can be obtained relatively simply, a complicated calculation is not needed, and calculation time is saved.

### BRIEF DESCRIPTION OF THE DRAWINGS

FIG. 1 shows a parameter diagram of an axisymmetric hanging droplet contour curve of the first embodiment of the present invention;

FIG. 2 shows a parameter diagram of an axisymmetric droplet contour curve by the hanging droplet method in the second embodiment of the present invention;

FIG. 3 shows a parameter diagram of an axisymmetric droplet contour curve by the sessile droplet method in the third embodiment of the present invention.

### REFERENCE NUMBERS

1 droplet contour curve
2 auxiliary platform
3 ruler
4 measurement point
5 pixel layer used to calculate the volume of the droplet
11 droplet contour curve
12 auxiliary platform
13 ruler
14 measurement point
15 measurement point
16 pixel layer used to calculate the volume of the droplet

### DETAILED DESCRIPTION

The present invention will be further described below through the following embodiments. It should be understood that the following embodiments are only used to illustrate the present invention, not to limit the present invention.

In one embodiment of the present invention, an image collection device is used to take images of a droplet suspended under the surface of a horizontal auxiliary platform, and the images are processed to extract a droplet contour curve. However, as the present invention, an auxiliary platform is not necessarily required, the solid surface on which the hanging droplet is formed in actual life can be sharp, irregular, or orifice-shaped, such as a needle tube, as long as an image of the photographed hanging droplet is obtained.

Selecting a measurement point on the droplet contour curve; and measuring the geometrical parameters related to the selected measurement point on the droplet contour curve, and calculating the surface tension of a liquid using the following formula:

$$σ = \frac{Δρ gV + P π {R}^{2}}{2 π R sin ( θ )} ,$$

wherein σ is the surface tension of the liquid. Δρ is the density difference between the liquid and the atmosphere, g is the local gravitational acceleration, P is the pressure at the cross section of the droplet cut from the horizontal plane of the measurement point, R is the radius of a circular surface formed by cutting the droplet from the horizontal plane of the measurement point, θ is the inclination angle between the tangent line of the measurement point on the droplet and the horizontal plane, and V is the droplet volume at the lower part of the cross section of the droplet cut from the horizontal plane of the measurement point.

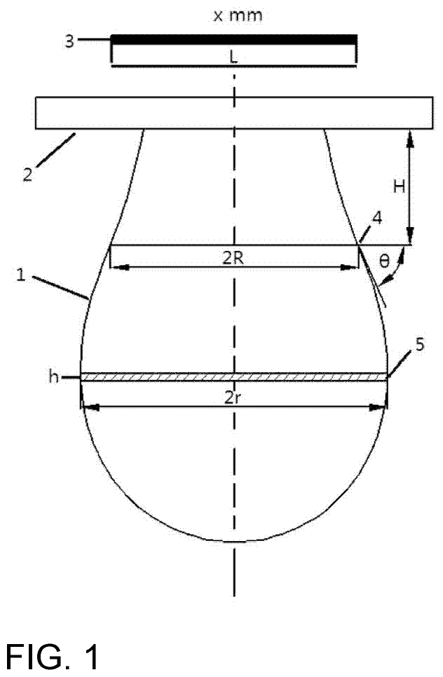

The implementation details of the specific process of the first embodiment of the present invention are described below with reference to FIG. 1.

Firstly, the image of a hanging droplet suspended on an auxiliary platform 2 and the auxiliary platform is captured by the image collection device. Then the collected images are processed to obtain a droplet contour curve 1 and the outermost boundary contour line of the auxiliary platform 2. The method of image collection and processing is a general method of image processing, which is very mature, and has been applied to the products such as contact angle measuring instruments.

After the processes of image collection and processing are carried out, the droplet contour curve 1 and the outermost boundary contour line of the auxiliary platform can be obtained. The droplet contour curve to be measured is shown in FIG. 1, the figure comprises a ruler 3 of the image, and the droplet contour curve 1 and the lower surface of the auxiliary platform 2 are complete. In this embodiment, the lower surface of the platform is horizontal.

After the image of the droplet contour curve is obtained, the values of the relevant geometric parameters are measured, as shown in FIG. 1, a measurement point 4 is required to be arranged before the parameters are measured. The vertical distance between the measurement point and the auxiliary platform is not zero, that is, the measurement point is not in contact with the auxiliary platform and is not the top point of the lowest vertex of the hanging droplet.

After the measurement points are set, the true values of the parameters of the droplet contour curve can be obtained in the following ways. Specifically, the cross-measurement point 4 is made as a horizontal straight line intersecting the droplet contour curve at another point. The main geometric parameters related to the measurement point on the measured droplet contour curve include several simple geometric parameters, namely a vertical distance H from the vertex of the droplet contour curve to the measurement point, the radius of curvature R at the vertex of the droplet contour curve, a distance 2R between the intersection of the droplet contour curve and the horizontal line crossing the measurement point, and the inclination angle θ of the droplet contour curve at the measurement point. That is, the horizontal distance 2R from the intersection point to the measurement point 4, the vertical distance H from the measurement point 4 to the lower surface of the auxiliary platform 2, the angle θ between the tangent line to the droplet contour curve passing through the measurement point 4 and the horizontal line, and a length L of the picture scale of the droplet contour curve are measured. The measured length (2R, H) is divided by the ruler length L measured in the picture and is multiplied by an actual length xmm of the ruler to obtain the true value of each parameter of the droplet contour curve.

For the pressure value at the cross section of the measurement point, there are many ways to calculate, for example, in this embodiment, the auxiliary platform is flat and level, and can be obtained by the formula P=ΔρgH, wherein Δρ is the density difference between the liquid and the atmosphere, and can be measured or queried by other ways, g is the local gravitational acceleration, and H is the height of the liquid cross section from the lower bottom surface of the upper auxiliary platform.

In addition, there are many ways to calculate the liquid volume V, the liquid volume refers to the liquid volume contained between the horizontal cross-section passing through the measurement point 4 and the apex of the droplet contour curve. For example, (the liquid volume) can be calculated according to the droplet contour curve in the following way. The hanging droplet contour image can be layered by pixels in the height direction to calculate the liquid volume, and the height of each layer is only one pixel. Taking any of the pixel layers 5 for consideration, the volume of the pixel layer 5 is πr²h, wherein r is half the true length of the pixel layer, and h is the true height of a pixel. Adding up the volume of all the pixel layers of the hanging droplet below the horizontal section where the measurement point 4 is located can obtain the liquid volume V from the plane of the measurement point to the apex of the droplet contour curve.

In more detail, the droplet volume from the measurement point to the apex of the droplet contour curve is the liquid volume contained between the horizontal plane of the measurement point and the apex of the droplet contour curve, which can be calculated by the formula

$$V = π {\sum }_{i = 0}^{N} {r}^{2} h ,$$

wherein V is the calculated liquid volume, h is the true height of each pixel in the image, and i is the calculated pixel layer, i=0 is the pixel layer where the measurement point is located, i=N is the pixel layer at the apex of the droplet contour curve, and r is the radius of the droplet contour curve on the i-th pixel layer. Therefore, this embodiment can measure the surface tension of the liquid by measuring the geometric parameters of a point on the axisymmetric hanging droplet and the volume of the droplet below the horizontal section of the point.

In order to verify the validity of the proposed measurement method, this embodiment uses the method of the present invention to measure and calculate the surface tension of pure water. Image collection of pure water droplets at 20° C., 25° C., and 30° C. was carried out by an industrial camera, the contour curves of pure water droplets at various temperatures were extracted, and the relevant geometric parameters were measured, which were substituted into the calculation method of the present invention to measure and obtain that the values of the suspended droplet surface tension of pure water at 20° C., 25° C., and 30° C. were 71.82 mN/m, 71.24 mN/m, 70.56 mN/m, and the standard values of pure water obtained from literature search were 72.75 mN/m, 72 mN/m, 71.18 mN/m, the measurement deviation is less than 2%, it can be seen that the surface tension of the liquid calculated by the method of the present invention is correct.

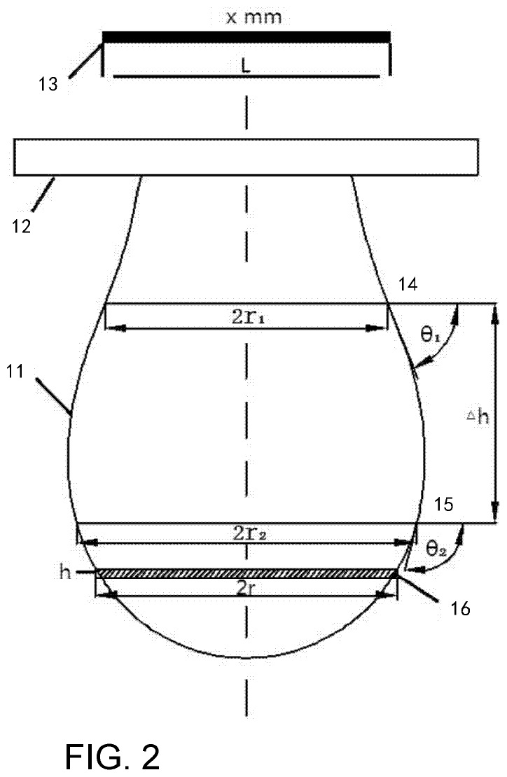

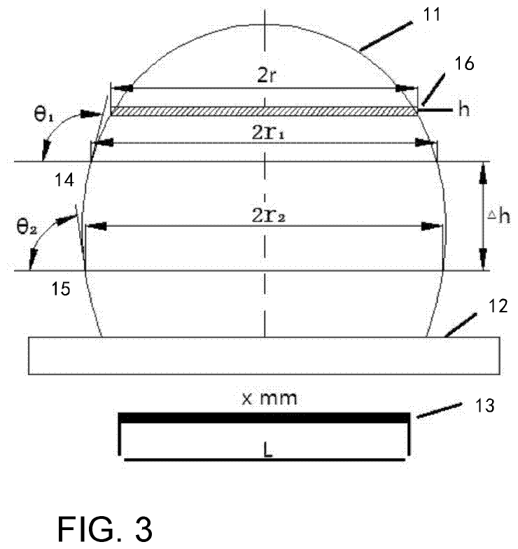

An auxiliary platform is used in another embodiment of the present invention, an image collection device is used to take images of (a droplet) suspended under the surface of an auxiliary platform (See FIG. 2) or the image of the droplet laid on the auxiliary platform (See FIG. 3), however, as the present invention, an auxiliary platform is not necessarily required, the solid surface on which the hanging droplet is formed in actual life can be sharp, irregular, or orifice-shaped, such as a needle tube, so it is only necessary to obtain the photographed hanging droplet image.

The images are processed to extract the droplet contour curve. Select two measurement points that are not on the same horizontal plane on the droplet contour curve. Measure separately geometrical parameters related to the two measurement points on the droplet contour curve.

The calculation method of the surface tension of the hanging droplet is:

$$σ = \frac{Δρ g ( {V}_{1} {r}_{2}^{2} - {V}_{2} {r}_{1}^{2} ) - Δ ρ g Δ h π {r}_{1}^{2} {r}_{2}^{2}}{2 π {r}_{1} {r}_{2} ( {r}_{2} sin {θ}_{1} - {r}_{1} sin {θ}_{2} )}$$

The calculation method of the surface tension of the sessile droplet is:

$$σ = \frac{Δρ g Δ h π {r}_{1}^{2} {r}_{2}^{2} - Δ ρ g ( {V}_{1} {r}_{2}^{2} - {V}_{2} {r}_{1}^{2} )}{2 π {r}_{1} {r}_{2} ( {r}_{2} sin {θ}_{1} - {r}_{1} sin {θ}_{2} )}$$

wherein σ is the surface tension of the liquid, Δρ is the density difference between the liquid and the atmosphere, which can be obtained by other means of measurement or literature search, etc., g is the local gravitational acceleration, Δh is the height difference between the two measurement points, r₁ and r₂ are respectively the radius of the circular surface formed by intercepting the droplet through the horizontal plane of the two selected measurement points, θ₁ and θ₂ are respectively inclination angles between a tangential line of the two selected measurement points on the droplet and the horizontal plane, V₁ and V₂ are respectively the droplet volume below the cross section formed by cutting the droplet from the horizontal plane of the two selected measurement points.

The implementation details of the specific process of the first embodiment of the present invention are described below with reference to FIG. 2.

Firstly, the image of the droplet suspended on an auxiliary platform 12 and the auxiliary platform is captured by the image collection device. Then the collected images are processed to obtain a droplet contour curve 11 and the outermost boundary contour line of the auxiliary platform 12. The method of image collection and processing is a general method of image processing, which is very mature, and has been applied to the products such as contact angle measuring instruments.

After the process of image collection and processing, the droplet contour curve 11 and the outermost boundary contour line of the auxiliary platform can be obtained. The droplet contour curve to be measured is shown in FIG. 2, which includes a ruler 13 of the figure, and has the complete droplet contour curve 11 and a lower surface of the auxiliary platform 12. In this embodiment, the lower surface of the auxiliary platform 12 serves as a horizontally placed auxiliary support surface.

After obtaining the image of the droplet contour curve, the values of the relevant geometric parameters were measured, as shown in FIG. 2, a measurement point 14 and a measurement point 15 that are not on the same horizontal plane need to be set before measuring the parameters.

After setting the measurement points, the true value of each parameter of the droplet contour curve can be obtained in the following way. Specifically, the suspended droplets are all axisymmetric. The horizontal straight line crossing respectively through the measurement point 14 and the measurement point 15 intersects the droplet contour curve at another point. The main geometric parameters related to the measurement point on the measured droplet contour curve include several simple geometric parameters, such as the height difference Δh between two selected measurement points on the droplet contour curve, distances 2r₁, 2r₂ between droplet contour curve and two intersection points on the horizontal line through the measurement point, and the inclination angles θ₁, θ₂ of the droplet contour curve at the measurement point. That is, measuring the horizontal distance 2r₁, 2r₂ from the corresponding intersection point to measurement point 14 and measurement point 15 respectively, measuring the height difference Δh between the two measurement points, measuring the ruler length L, and the angles between the tangent to the horizontal line of the droplet contour curve through measurement point 14 and measurement point 15 are θ₁ and θ₂ respectively.

In the figure, Xmm represents the actual measurement length of the ruler, L represents the measurement length on the image, and the ratio can be changed by X/L. The measured length (2r₁, 2r₂, Δh) is divided by the ruler length L measured in the figure and is multiplied by the actual length of the ruler to obtain the true value of each parameter of the droplet contour curve.

In addition, there are many ways to calculate the liquid volume V, the liquid volume refers to the liquid volume V₁, V₂ contained between the horizontal cross-section passing through the measurement point 14, the measurement point 15 and the apex of the droplet contour curve. For example, (the liquid volume) can be calculated according to the droplet contour curve in the following way. The hanging droplet contour image can be layered by pixels in the height direction to calculate the liquid volume, and the height of each layer is only one pixel. Taking any of the pixel layers 16 for consideration, the volume of the pixel layer 16 is πr²h, wherein r is half the true length of the pixel layer, and h is the true height of a pixel. Adding up the volume of all the pixel layers of the droplet below the horizontal section where the measurement point 15 and the measurement point 16 are located can obtain the liquid volume V₁, V₂ from the plane of the two measurement points to the apex of the droplet contour curve.

In more detail, the droplet volume from the measurement point to the apex of the droplet contour curve is the liquid volume contained between the horizontal plane of the measurement point and the apex of the droplet contour curve, which can be calculated by the formula

$$V = π {\sum }_{i = 0}^{N} {r}^{2} h ,$$

wherein V is the calculated liquid volume, h is the true height of each pixel in the image, and i is the calculated pixel layer, i=0 is the pixel layer where the measurement point is located, i=N is the pixel layer at the apex of the droplet contour curve, and r is the radius of the droplet contour curve on the i-th pixel layer. Therefore, the present invention can measure the surface tension of the liquid by measuring the geometric parameters of the two measurement points on the axisymmetric droplet that are not on the same horizontal plane and the droplet volume of the two measurement points below the horizontal section.

FIG. 3 shows a parameter diagram of a droplet contour curve when the sessile drop method is adopted in the third embodiment of the present invention. This method is similar to the method in FIG. 2, both of which are processed and calculated on the axisymmetric liquid image, and both of the surface tension can be calculated. The only difference lies in, one is hanging and the other is flat, because they all use a vertex as an original point, the coordinate systems are different, the formulas of the two are different, and part of the symbols of the molecules are interchanged.

In order to verify the validity of the proposed measurement method, this embodiment uses the hanging droplet method of the present invention to measure and calculate the surface tension of pure water. Image collection of pure water droplets at 20° C., 25° C., and 30° C. was carried out by an industrial camera, the contour curves of pure water droplets at various temperatures were extracted, and the relevant geometric parameters were measured, which were substituted into the calculation method of the present invention to measure and obtain that the values of the suspended droplet surface tension of pure water at 20° C., 25° C., and 30° C. were 71.64 mN/m, 71.33 mN/m, 70.24 mN/m, and the standard values of pure water obtained from literature search were 72.75 mN/m, 72 mN/m, 71.18 mN/m, the measurement deviation is less than 2%, it can be seen that the surface tension of the liquid calculated by the method of the present invention is correct.

In order to verify the correctness of the proposed measurement method, this embodiment uses the sessile droplet method of the present invention to measure and calculate the surface tension of pure water. Image collection of pure water droplets at 20° C., 25° C., and 30° C. was carried out by an industrial camera, the contour curves of pure water droplets at various temperatures were extracted, and the relevant geometric parameters were measured, which were substituted into the calculation method of the present invention to measure and obtain that the values of the suspended droplet surface tension of pure water at 20° C., 25° C., and 30° C. were 71.59 mN/m, 71.34 mN/m, 70.83 mN/m, and the standard values of pure water obtained from literature search were 72.75 mN/m, 72 mN/m, 71.18 mN/m, the measurement deviation is less than 2%, it can be seen that the surface tension of the liquid calculated by the method of the present invention is correct.

Without departing from the basic characteristics of the present invention, the present invention can be embodied in various forms. Therefore, the embodiments of the present invention are for illustration rather than limitation, because the scope of the present invention is defined by the claims rather than the specification. All changes falling within the scope defined by the claims or the equivalent scope of the defined scope should be understood to be included in the claims.

1. A method for measuring surface tension based on an axisymmetric droplet contour curve, comprising the following steps:
photographing a suspended droplet image, and extracting a droplet contour curve;
selecting a measurement point on the droplet contour curve; and
measuring the following geometrical parameters related to the selected measurement points on the droplet contour curve, and calculating the surface tension of a liquid using the following formula:
$$σ = \frac{Δρ gV + P π {R}^{2}}{2 π R sin ( θ )} ,$$
wherein σ is the surface tension of the liquid, Δρ is a density difference between the liquid and the atmosphere, g is a local gravitational acceleration, P is a pressure at a cross section of the droplet cut from a horizontal plane of the measurement point, R is the radius of a circular surface formed by cutting the droplet from the horizontal plane of the measurement point, θ is an inclination angle between a tangent line of the measurement point on the droplet and the horizontal plane, and V is a droplet volume at a lower part of the cross section of the droplet cut from the horizontal plane of the measurement point.

2. The method according to claim 1, wherein when an upper end surface of the droplet is a plane, the pressure P is obtained by the formula P=ΔρgH, where H is a height of the cross section from the upper end surface of the droplet.

3. The method according to claim 1, further comprising the following step: layering the images in a height direction by pixels, the height of each layer being only one pixel, wherein
the volume V is calculated by a formula
$$V = π {\sum }_{i = 0}^{N} {r}^{2} h ,$$
wherein h is the true height of each pixel of the image, i is the calculated pixel layer, i=0 is the pixel layer where the measurement point is located, i=N is the pixel layer at the apex of the droplet contour curve, and r is the radius of the droplet contour curve on the i-th pixel layer.

4. A method for measuring surface tension based on an axisymmetric droplet contour curve, comprising the following steps:
photographing a suspended droplet image, and extracting a droplet contour curve;
selecting two measurement points that are not on the same horizontal plane on the droplet contour curve; and
measuring geometrical parameters related to the selected two measurement points on the droplet contour curve, and calculating a surface tension of a liquid by means of the formula:
$$σ = \frac{Δρ g ( {V}_{1} {r}_{2}^{2} - {V}_{2} {r}_{1}^{2} ) - Δ ρ g Δ h π {r}_{1}^{2} {r}_{2}^{2}}{2 π {r}_{1} {r}_{2} ( {r}_{2} sin {θ}_{1} - {r}_{1} sin {θ}_{2} )} ,$$
wherein σ is the surface tension of the liquid, Δρ is a density difference between the liquid and the atmosphere, g is a local gravitational acceleration, Δh is the height difference between the two measurement points, r₁ and r₂ are respectively the radius of a circular surface formed by intercepting the droplet through the horizontal plane of the two selected measurement points, θ₁ and θ₂ are respectively inclination angles between a tangential line of the two selected measurement points on the droplet and the horizontal plane, and V₁ and V₂ are respectively a droplet volume below the cross section formed by cutting the droplet from the horizontal plane of the two selected measurement points.

5. The method according to claim 4, wherein the droplet image is layered by pixels in the height direction when calculating the liquid volume, and the droplet volume from the measurement point to the apex of the droplet contour curve is calculated by the formula
$$V = π {\sum }_{i = 0}^{N} {r}^{2} h ,$$
wherein V is the calculated liquid volume, h is the true height of each pixel in the image, i is the true height of each pixel of the image, and i is the calculated pixel layer, i=0 is the pixel layer where the measurement point is located, i=N is the pixel layer at the apex of the droplet contour curve, and r is the radius of the droplet contour curve on the i-th pixel layer.

6. A method for measuring surface tension based on an axisymmetric droplet contour curve, comprising the following steps:
photographing a suspended droplet image, and extracting a droplet contour curve;
selecting two measurement points that are not on the same horizontal plane on the droplet contour curve;
and measuring geometrical parameters related to the selected measurement point on the droplet contour curve, and calculating a surface tension of a liquid by means of the formula:
$$σ = \frac{Δρ g Δ h π {r}_{1}^{2} {r}_{2}^{2} - Δ ρ g ( {V}_{1} {r}_{2}^{2} - {V}_{2} {r}_{1}^{2} )}{2 π {r}_{1} {r}_{2} ( {r}_{2} sin {θ}_{1} - {r}_{1} sin {θ}_{2} )} ,$$
wherein σ is the surface tension of the liquid, Δρ is a density difference between the liquid and the atmosphere, g is a local gravitational acceleration, Δh is a height difference between the two measurement points, r₁ and r₂ are respectively the radius of a circular surface formed by intercepting the droplet through the horizontal plane of the two selected measurement points, θ₁ and θ₂ are respectively inclination angles between a tangential line of the two selected measurement points on the droplet and the horizontal plane, and V₁ and V₂ are respectively a droplet volume below the cross section formed by cutting the droplet from the horizontal plane of the two selected measurement point.

7. The method according to claim 6, wherein the droplet image is layered by pixels in the height direction when calculating the liquid volume, and the droplet volume from the measurement point to the apex of the droplet contour curve is calculated by the formula
$$V = π {\sum }_{i = 0}^{N} {r}^{2} h ,$$
wherein V is the calculated liquid volume, h is the true height of each pixel in the image, i is the calculated pixel layer, i=0 is the pixel layer where the measurement point is located, i=N is the pixel layer at the apex of the droplet contour curve, and r is the radius of the droplet contour curve on the i-th pixel layer.
